(19) United States
(12) Patent Application Publication
(10) Pub. No.: US 2006/0230463 A1
(43) Pub. Date: Oct. 12, 2006

(54) Method, apparatus, and computer program product for controlling copying and playback of digital data

(75) Inventors: Kevin Joel Cawlfield, Austin, TX (US); Shawn Patrick Mullen, Buda, TX (US); James Stanley Tesauro, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/101,618

(22) Filed: Apr. 7, 2005

(51) Int. Cl. H04L 9/32

(52) U.S. Cl. 726/27

(57) ABSTRACT

A method, apparatus, and computer program product are disclosed for controlling copying and playback of digital data. Digital data is selected that is to be stored using a portable digital storage medium. Data that is stored using the medium is capable of being accessed only when the medium is inserted into a drive that can be accessed by a data processing system. During manufacturing of the medium: a unique identifier is stored within the medium where the unique identifier identifies only that one particular medium, a copy of the unique identifier is also stored in a tag that is affixed to a surface of the medium, a public key/private key pair is selected for encrypting and decrypting data where data that has been encrypted using the private key of the pair is capable of being decrypted using only the public key of the pair, the public key of the pair is stored within the tag, the digital data is encrypted using the private key of the pair, and the encrypted data is stored using the medium.

### BACKGROUND OF THE INVENTION

1. Technical Field

The present invention is directed to data processing systems. More specifically, the present invention is directed to a method, apparatus, and computer program product for preventing illegal copying of digital data while permitting legal copying and playback of the data.

2. Description of Related Art

Music, movies, software, and other entertainment are often distributed to users as digital data that is stored on digital storage media, such as CD-ROM disks and DVD-ROM disks. When a user legitimately purchases the entertainment, the user often receives a disk on which the entertainment is recorded in a digital format. The user may then have unlimited access to playing the entertainment on a home or personal system such as a DVD player or computer system that is capable of presenting the digital data.

The digital data that is purchased on a disk is not typically encrypted. Therefore, the data is easily copied from the disk that was purchased to another disk or system. Illegal copying of the digital data has been a problem that has plagued the manufacturers of this digital entertainment. It is very easy to copy non-encrypted digital data from a disk that was legitimately purchased to another disk for distribution to others that did not legitimately purchase the digital entertainment.

Encryption algorithms are known to ensure that only the intended recipient of a message may read and access the message. One known encryption algorithm is an asymmetric, or public key, algorithm. The public key algorithm is a method for encrypting messages sent from a first computer system to a second computer system. This algorithm provides for a public key/private key pair for each computer system which is unique to each computer system. Each computer system has its own associated public key/private key pair which is stored within that computer system. One known asymmetric, or public key, encryption algorithm is the Rivest, Shamir, and Adleman algorithm, commonly known as RSA algorithm.

Radio frequency identification (RFID) tags are known. A passive RFID tag can be activated when it receives a signal of a particular frequency. In response to a receipt of the signal, the RFID tag then produces a backscatter signal that can be read as the response from the RFID tag. In addition, the activation signal can be modulated to produce a different signal. In response to this different signal, the RFID tag then responds with different data when it receives this different signal.

Therefore, a need exists for a method, apparatus, and computer program product for preventing illegal copying of digital data while permitting legal copying and playback of the data.

### SUMMARY OF THE INVENTION

A method, apparatus, and computer program product are disclosed for controlling copying and playback of digital data. Digital data is selected that is to be stored using a portable digital storage medium. Data that is stored using the medium is capable of being accessed only when the medium is inserted into a drive that can be accessed by a data processing system. During manufacturing of the medium: a unique identifier is stored within the medium where the unique identifier identifies only that one particular medium, a copy of the unique identifier is also stored in a tag that is affixed to a surface of the medium, a public key/private key pair is selected for encrypting and decrypting data where data that has been encrypted using the private key of the pair is capable of being decrypted using only the public key of the pair, the public key of the pair is stored within the tag, the digital data is encrypted using the private key of the pair, and the encrypted data is stored using the medium.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of computer systems that includes the present invention in accordance with the present invention;

FIG. 2A is a block diagram of a first computer system that includes the present invention in accordance with the present invention;

FIG. 2B is a block diagram of a second computer system that includes the present invention in accordance with the present invention;

FIG. 3 is a pictorial representation of a digital storage medium, such as a disk, that includes a field for storing a unique digital storage medium identifier (DMID) and includes an RFID tag affixed to the disk in accordance with the present invention;

FIG. 4 depicts a high level flow chart that illustrates selecting a unique DMID and public/private key pair for a particular digital storage medium during the manufacturing process of the particular digital storage medium in accordance with the present invention;

FIGS. 5A-1 and 5A-2 illustrate a high level flow chart that depicts decrypting and playing data in a first system in accordance with the present invention;

FIGS. 5B-1 and 5B-2 depict a high level flow chart that depicts copying data from a first system to a second system for playback by the second system at a later time without requiring the presence of the digital storage medium in the second system during playback in accordance with the present invention;

FIG. 6 illustrates a high level flow chart that depicts an RFID tag responding to a receipt of a first signal by transmitting data that is stored in a first field in the RFID tag in accordance with the present invention; and

FIG. 7 depicts a high level flow chart that illustrates an RFID tag responding to a receipt of a second signal by transmitting data that is stored in a second field in the RFID tag in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

A method, apparatus, and computer program product are disclosed for protecting digital data by controlling copying and playback of the digital data. Although this digital data may be any type of digital data, the digital data will typically be entertainment data such as music, movies, or software.

The present invention provides for an RFID tag to be affixed to each and every digital storage medium, such as a disk, that contains the data to be protected. Typically, the digital data will be stored on a disk, such as a CD-ROM or DVD-ROM disk.

According to the present invention, each disk will have assigned to it a unique digital medium identifier (DMID) during manufacturing of the disk. This DMID will uniquely identify each and every different disk. A disk's DMID will be stored in a field in the disk itself during manufacturing of the disk. Typically, each disk will include some format fields at the beginning of the data that is stored on the disk. The DMID for a particular disk will be stored in one of the fields in that disk.

In order to decrypt the data that is stored on the disk, an RFID tag must be present that was affixed to the disk at manufacture. The particular RFID tag that was affixed to the disk at manufactured is identified by reading data that is stored in the tag itself. The unique DMID that is assigned to a particular disk will have been stored in the RFID tag at manufacture. The unique DMID that is assigned to the particular disk must be read from the tag that is affixed to the disk. Otherwise, the encrypted data that is stored on the disk cannot be decrypted or accessed.

In addition, a unique particular public/private key pair will be assigned to each and every different disk. The private key will be used to encrypt data that is stored on the disk. Therefore, the data that is stored on disks according to the present invention will be encrypted. According to the preferred embodiment, the data will be encrypted using the private key that is assigned to the particular disk on which the data is stored. In order to decrypt the data, the corresponding public key of the key pair is needed.

For example, if a manufacturer wishes to produce a thousand copies of a particular movie and disks, a thousand different key pairs will be needed, each one assigned to only one of the disks. In addition, a thousand different DMIDs are also needed, each one assigned to only one of the disks.

Each disk will have an RFID tag affixed to it. The DMID that is assigned to the disk to which a particular RFID tag is affixed will be stored in a first field in the RFID tag. The public key that is assigned to the disk to which this particular RFID tag is affixed will be stored in a second field in the RFID tag.

When a user legitimately purchases a disk, the disk will include an RFID tag affixed to it. That particular disk's DMID and public key will be stored in the RFID tag that is affixed to the disk.

When the user wishes to play the encrypted data that is stored on the disk, the RFID tag and the DMID that is stored in the field in the disk are used as described below to ensure that only legitimate copying and playback can be performed. When the user wishes to play the encrypted data on the disk, the system into which the disk is inserted will read the DMID that is stored on the disk and compare it to the DMID that is stored in the RFID tag that is affixed to this disk. If no RFID tag is detected or if the DMID that is read from the disk does not match the DMID that is read from the RFID tag, the data cannot be read from the disk because the data cannot be decrypted.

If an RFID tag is detected and the DMID that is read from the disk matches the DMID that is read from the RFID tag, a public key is read from the RFID tag. This public key is then used to decrypt the data that is stored on the disk. The decrypted data can then be played back.

Therefore, according to the present invention, in order to decrypt the data, an RFID tag must be detected. In addition, this RFID tag must be the tag that includes the DMID that is assigned to the disk to which the RFID tag is affixed. Further, the public key that is stored in the RFID tag must be the public key that was assigned to this particular disk during manufacturing of this disk. Only the public key that corresponds to the private key that was used to encrypt the data can be used to decrypt the data. Thus, because the private key that is part of the selected private/public key pair is used to encrypt the data, only the public key that is part of that key pair can be used to decrypt the data.

If the data from a disk is illegally copied to another disk, that other disk cannot be used to read the data because no RFID tag will exist on the second disk. When a system attempts to access and play the data on the second disk, the system will attempt to read the DMID that should be stored in an RFID tag that is affixed to the disk. Since no RFID tag will be affixed to the second disk, the data on the second disk cannot be read.

Therefore, the present invention permits a system to play a disk that has an RFID tag so long as that RFID tag was associated with that particular disk during manufacture of the disk. A particular RFID tag is associated with a particular during manufacture by storing the particular disk's DMID and public key in the particular RFID tag.

In addition to the process described above, the present invention also permits the legitimate copying of the digital data. The digital data can be legitimately copied to another disk, computer system, or player for later use without the need for the disk itself being present. The present invention controls this copying, however.

The present invention controls the legitimate copying of the data by using a certificate. When digital data is copied from a disk, a certificate is created for the data. This certificate must be present in order to read, i.e. play, the copied data. In addition, the data can only be played back by a system that includes a security device and that executes the present invention.

When digital data is to be copied from a disk, the data must first be decrypted using the process described above. Thus, the disk that contains the data must be inserted into a first computer system and the decryption process described above executed.

The first computer system can be coupled to a second computer system into which the data is to be copied. This second computer system also must include a security device that includes its own public/private key pair that is uniquely assigned with that second system. Thus, this particular public/private key pair is associated with only this particular second system. When the data is to be copied to the second system, the first system reads the second system's public key from the second system. The second system maintains its private key in protected storage such that the second system's private key is not accessible outside of the security system in the second system.

The first system then decrypts the data from the disk as described above. The first system creates a certificate for this data. The first system stores an expiration date in the certificate. Once the data is decrypted, it is then re-encrypted using the second system's public key that the first system read from the second system and the certificate that was created for the data. The re-encrypted data can then be stored in the second system. The certificate is also stored in the second system. However, the certificate and the re-encrypted data are not stored together in the second system. The digital storage medium that includes the affixed RFID tag is not needed when a valid certificate is found. The valid certificate is used in order to decrypt the data.

The second system can then read and playback the re-encrypted data that is stored within the second system. In order to playback the re-encrypted data, the second system searches for a disk. If no disk is found, the second system searches for a certificate. A certificate should be found in this case. A determination is made as to whether the certificate has expired by comparing the expiration date in the certificate to the current date and time. If the certificate has expired, the re-encrypted data cannot be decrypted or played back. If the certificate has not expired, the second system then uses the certificate and the second system's private key to decrypt the data. The decrypted data can then be played back by the second system without the need for the original disk being present.

Thus, the copied data can be replayed for the lifetime of the certificate. Once the certificate reaches its expiration date and then is invalid, the copied data can no longer be played. In order to again play the copied data, a user would have to update the certificate by restoring the copied data in a manner such as described above. Alternatively, a certificate could be restored with a new expiration date using a hot sync method when the second system is coupled to a first system when the disk and associated RFID are present in the first system.

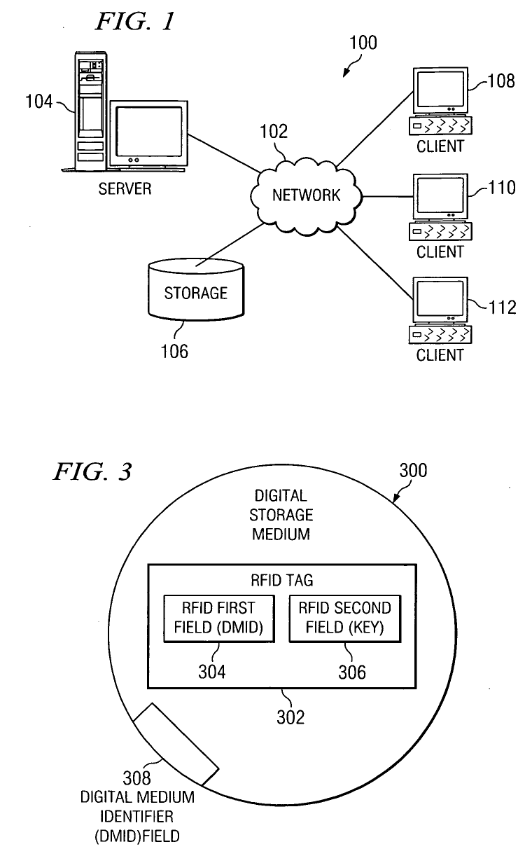

FIG. 1 is a pictorial representation of a network of computer systems that includes the present invention in accordance with the present invention. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers, network computers, or other computing devices. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages.

Of course, network data processing system 100 also may be implemented as a number of different types of networks, such as for example, an intranet, a local area network (LAN), a wide area network (WAN), or a wireless network. FIG. 1 is intended as an example, and not as an architectural limitation for the present invention.

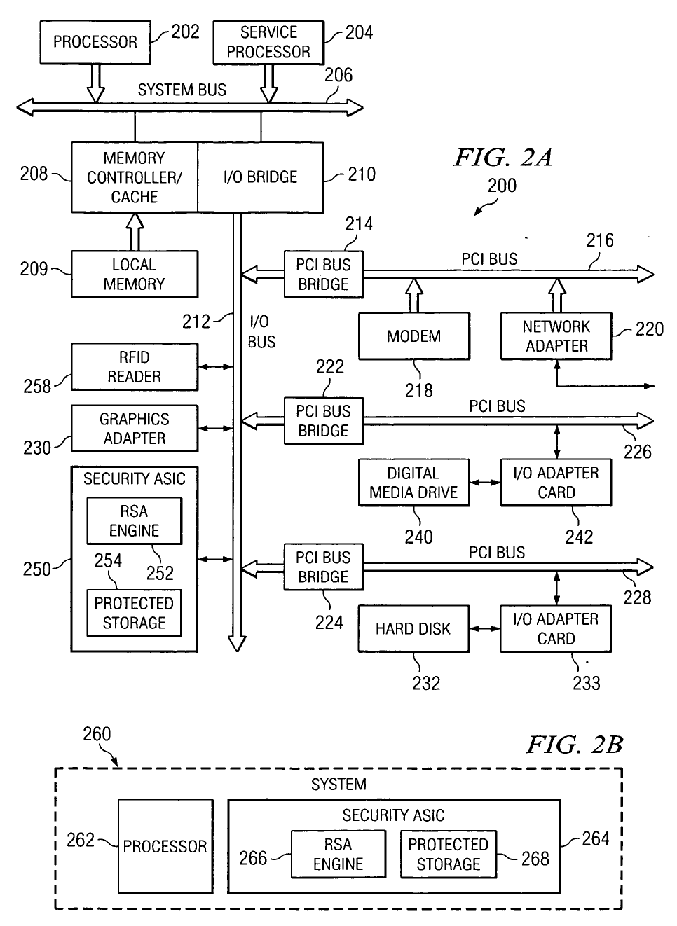

FIG. 2A is a block diagram of a first computer system that includes the present invention in accordance with the present invention. First computer system 200 may be a symmetric multiprocessor (SMP) system including a plurality of processors 202 and 204 connected to system bus 206. Alternatively, a single processor system may be employed. In the depicted example, processor 204 is a service processor. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to other computers may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 may also be connected to I/O bus 212 as depicted, either directly or indirectly.

A storage device, such as hard drive 232 is coupled to a PCI bus, such as bus 228, via an I/O adapter card 233. Hard drive 232 may be implemented using any type of technology. For example, hard drive 232 may be a SAS drive or may be a SCSI drive. Adapter card 233 then maps PCI bus as either a SCSI bus or SAS bus depending on the type of interface technology supported by the hard drive 232.

Another storage device, such as a digital media drive 240, is included in system 200. Digital media drive 240 is coupled to PCI bus 226 via an I/O adapter card 242. Digital media drive 240 may be utilized to read, i.e. play, data that is stored on a digital storage medium, such as a CD-ROM or a DVD-ROM, when that digital storage medium is inserted into digital media drive 240. Other types of digital storage media may be utilized in digital media drive 240 to play the data that is stored in the digital storage medium.

Computer system 200 also includes a security ASIC 250. Security ASIC 250 includes an engine, such as an RSA engine 252, that is capable of encrypting and/or decrypting data using public/private key pairs. Engine 252 is capable of encrypting and/or decrypting data using keys that are stored in protected storage 254 or keys that are transmitted to engine 252 from outside of engine 252.

Encryption/decryption engine 252 includes an encryption/decryption algorithm, which is utilized to encode and decode data. Engine 252 can preferably perform public/private key encryption. Encryption algorithms are known to ensure that only the intended recipient of a message can read and access the message. One known encryption algorithm is an asymmetric, or public key, algorithm. This algorithm provides for a key pair including a public key and a private key. An example of such an encryption scheme is an RSA key pair system.

Engine 252 may access a protected storage device 254. Protected storage device 254 is accessible only through engine 252 and is a one-time writable device. Therefore, storage device 254 cannot be read or written to by devices outside of engine 252.

Protected storage 254 is included in which one or more keys are stored. The key(s) that is stored in protected storage 254 remains inside protected storage 254. Any key stored in protected storage 254 is not readable from outside of security ASIC 250. Thus, only engine 252 can access protected storage 254 to read and then use the key that is stored there.

System 200 also includes an RFID reader 258 that is capable of receiving and reading signals that are transmitted by an RFID tag.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

FIG. 2B is a block diagram of a second computer system 260 that includes the present invention in accordance with the present invention. Computer system 260 includes a processor 262 and its own security ASIC 264. Computer system 260 also includes other components, such as those depicted in FIG. 2A, that are not depicted in FIG. 2B.

Security ASIC 264 includes an engine, such as an RSA engine 266, that is capable of encrypting and/or decrypting data using public/private key pairs. Engine 266 is capable of encrypting and/or decrypting data using keys that are stored in protected storage 268 or keys that are transmitted to engine 266 from outside of engine 266.

Protected storage 268 is included in which one or more keys are stored. The key(s) stored in protected storage 268 remains inside protected storage 268. Any key stored in protected storage 268 is not readable from outside of security ASIC 264. Thus, only engine 266 can access protected storage 268 to read and then use the key that is stored there.

In one example embodiment, second computer system 260 is a system that is capable of processing and playing MP3 files.

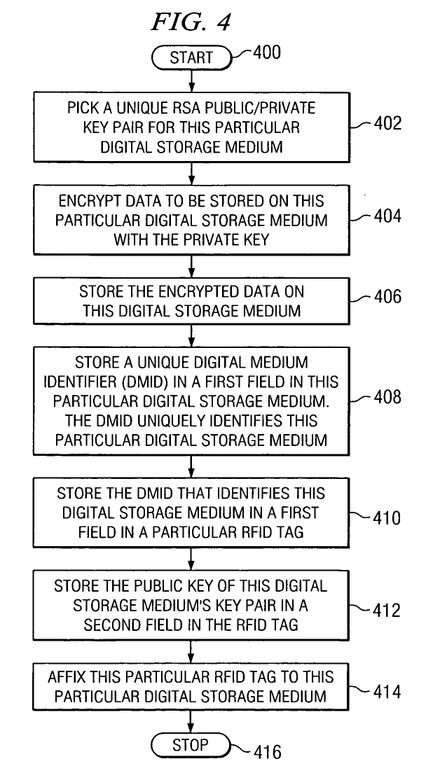

FIG. 3 is a pictorial representation of a digital storage medium 300 that includes an RFID tag 302 that is affixed to the digital storage medium 300 and includes a field 308 for storing a unique digital storage medium identifier (DMID) in accordance with the present invention. Digital storage medium 300 is preferably a CD-ROM or DVD-ROM disk although digital storage medium 300 may be any type of digital storage media.

According to the present invention, each disk will be assigned its own unique digital storage medium identifier (DMID). Preferably, a DMID will be assigned to a particular disk when that particular disk is manufactured.

A DMID will identify only one disk. For example, if the digital storage medium is a CD-ROM disk, each CD-ROM disk will be assigned its own DMID. Thus, a particular DMID will identify only one CD-ROM disk. If thousands of CD-ROM disks are manufactured, each one will be assigned its own unique DMID at the time of manufacture. Thus, there will be thousands of DMIDs assigned at manufactured, one for each CD-ROM disk. The DMID that is assigned to a particular disk will be stored in that particular disk's DMID field 308.

In addition to assigning a unique DMID to each disk that is manufactured, a unique private/public key pair will also be assigned. Therefore, each individual disk will have its own DMID and its own unique public/private key pair.

Also according to the present invention, an RFID tag 302 is affixed to the disk at the time of manufacture. Each RFID tag will include at least two fields. For example, RFID tag 302 includes a first field 304 and a second field 306.

The DMID that has been assigned to a particular disk is stored in first field 304 of the RFID tag that is affixed to the particular disk. The public key that is unique to the particular disk is stored in the second field 306 of the RFID tag that is affixed to the particular disk.

The data that is to be stored on the particular disk is then encrypted using the private key that is unique to the particular disk. The encrypted data is then stored on the particular disk to complete the manufacturing process of the disk.

Therefore, during the manufacturing process, when a particular disk is manufactured, a unique DMID is assigned to that particular disk, a unique private/public key pair is assigned to that particular disk, the unique DMID is stored in the DMID field in the disk itself, a copy of the DMID is stored in a first field in a particular RFID tag, the public key of the key pair is stored in a second field in that particular RFID tag, the particular RFID tag is affixed to the disk, data to be stored on the particular disk is encrypted using the private key of the unique key pair assigned to the particular disk, and the encrypted data is stored on the particular disk.

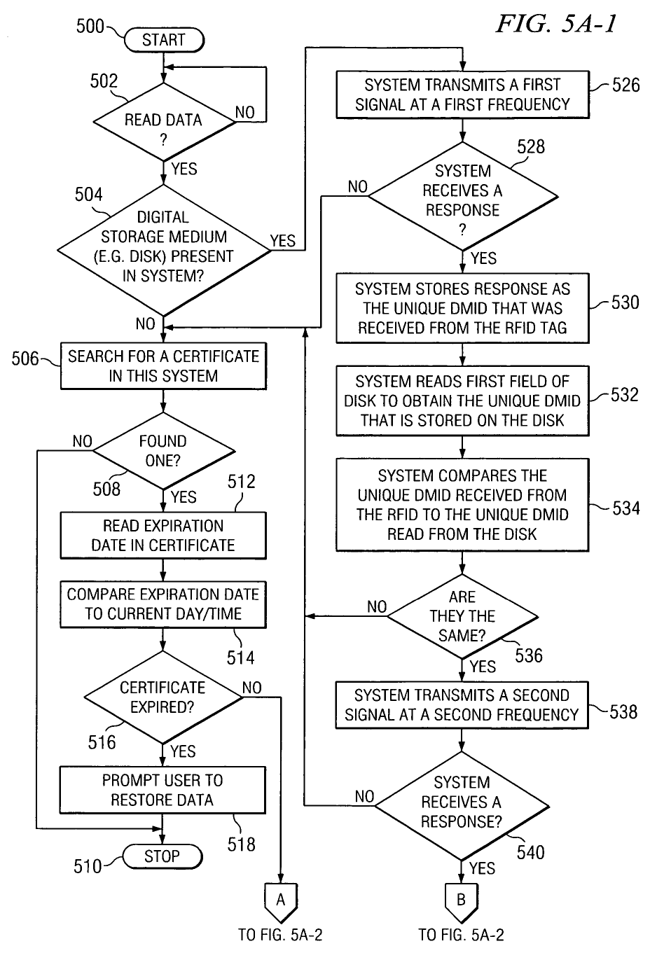

FIG. 4 depicts a high level flow chart that illustrates selecting a unique DMID and public/private key pair for a particular digital storage medium during the manufacturing process of the particular digital storage medium in accordance with the present invention. According to the preferred embodiment, the digital storage medium is a disk.

The process starts as depicted by block 400 and thereafter passes to block 402 which illustrates picking a unique encryption key pair, such as an RSA public/private key pair, for this particular digital storage medium. Next, block 404 depicts encrypting data to be stored on this particular digital storage medium using the private key of the key pair that was picked for this particular digital storage medium.

Thereafter, block 406 illustrates storing the encrypted data on this particular digital storage medium. Block 408, then, depicts storing a unique digital medium identifier (DMID) in a first field in this particular digital storage medium. This DMID uniquely identifies this particular digital storage medium.

The process then passes to block 410 which illustrates storing the DMID that identifies this particular storage medium in a first field in a particular RFID tag. Next, block 412 depicts storing the public key of the key pair that was picked for this particular digital storage medium in a second field in the particular RFID tag. Next, block 414 illustrates affixing this particular RFID tag to this particular digital storage medium. The process then terminates as depicted by block 416.

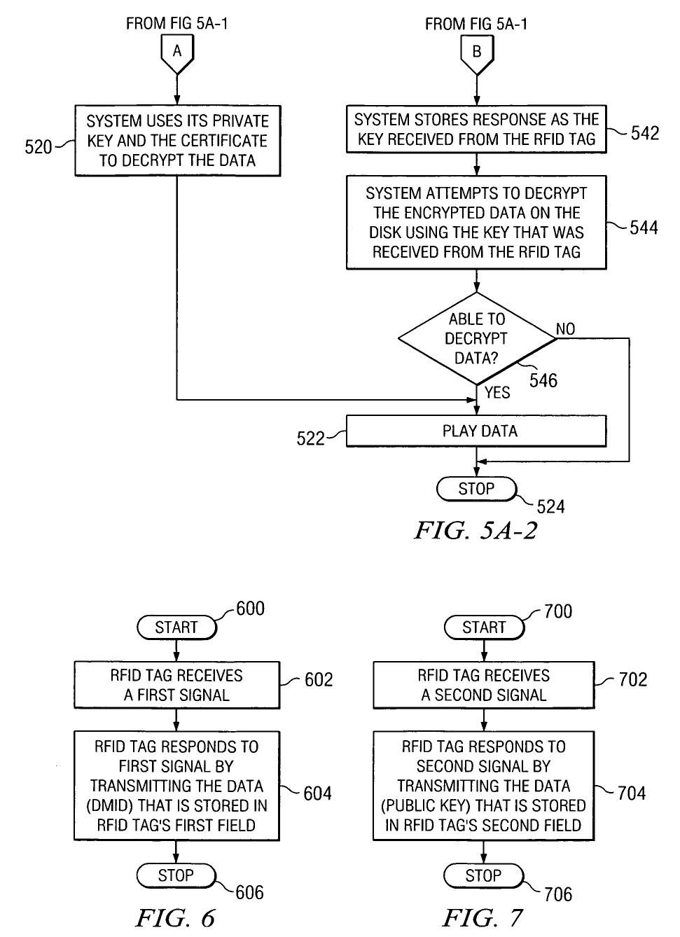

FIGS. 5A-1 and 5A-2 illustrate a high level flow chart that depicts decrypting and playing data in a first system in accordance with the present invention. The process starts as depicted by block 500 and thereafter passes to block 502 which illustrates a determination of whether or not data has been selected to be read. Data to be read may include data to be processed or data to be played such as music or a movie. If a determination is made that data is not to be read, the process passes back to block 502. If a determination is made that data is to be read, the process passes to block 504 which depicts a determination of whether or not a digital storage medium, such as a CD-ROM disk, is present in this system. If a determination is made that there is no digital storage medium currently present in this system, the process passes to block 506 which illustrates searching in this system for a certificate that is associated with the data that is to be read.

The following is a preferred embodiment for associating a certificate with particular data. When a certificate is originally stored in a system for particular data, an identifier for the certificate is stored in a certificate directory in the system. This identifier is an identifier, such as a name of number, that identifies the particular certificate. In addition, a checksum or first x number of bytes of the data will also be stored in the directory along with the identifier of the particular certificate. In this manner, the certificate is associated with the particular data.

When a determination is made as to whether a certificate exists for particular data, the checksum or first x number of bytes of the data can be used as an index into the directory to attempt to locate a certificate identifier. If a certificate identifier is found, that certificate identifier can then be used to locate the certificate that is associated with this particular data.

Next, block 508 illustrates a determination of whether or not a certificate has been found that is associated with the data that was selected to be read. If a determination is made that no such certificate was found in this system, the process terminates as illustrated by block 510. Referring again to block 508, if a determination is made that a certificate was found that is associated with the data that is to be read, the process passes to block 512 which depicts reading the expiration date that is stored in the certificate. This expiration date is the expiration date for the certificate. After this expiration date has passed, the certificate is no longer valid and cannot be used to decrypt data.

Next, block 514 illustrates comparing the expiration date that was stored in the certificate to the current day and time. Thereafter, block 516 depicts a determination of whether or not the certificate has expired. If a determination is made that the certificate has expired, the process passes to block 518 which illustrates prompting the user to restore the data by copying the data again which will cause a new certificate with a new expiration date to be created. The process then terminates as depicted by block 510.

Referring again to block 516, if a determination is made that the certificate has not expired, the process passes to block 520 which illustrates the system using the certificate and the private key that the system has stored within a security ASIC that is included within the system to decrypt the data. Next, block 522 depicts playing the decrypted data. The process then terminates as illustrated by block 524.

Referring again to block 504, if a determination is made that a digital storage medium is present in the system, i.e. a disk is inserted into the system's disk drive, the process passes to block 526 which depicts the system transmitting a first signal at a first frequency. Next, block 528 illustrates a determination of whether or not this system received a response to the transmission of its first signal. If a determination is made that no response was received to the first signal, the process passes back to block 506. If no RFID tag is affixed to the disk, no response will be received. Referring again to block 528, if a determination is made that this system did receive a response to its first signal, the process passes to block 530.

Block 530 depicts this system storing the response it received. This response is stored in the system and identified as the unique DMID that was received from the RFID tag that is affixed to the particular digital storage medium that was found inserted into the system. Next, block 532 illustrates the system reading the first field of the disk, i.e. the digital storage medium found in the system, to obtain the DMID that is stored in the disk itself.

Thereafter, block 534 depicts the system comparing the unique DMID that was received from the RFID tag to the unique DMID that was read from the disk itself. Block 536 illustrates a determination of whether or not the DMID received from the RFID tag is the same as the DMID that was found stored in the disk itself. If the two DMIDs are not the same, the process passes back to block 506. The RFID tag that is affixed to the disk must be the same RFID tag that was affixed during manufacture of the disk. Thus, the RFID tag must contain the DMID that is assigned to the disk to which the RFID tag is affixed. If the two DMIDs are the same, the process passes to block 538 which depicts the system transmitting a second signal at a second frequency.

Next, block 540 illustrates a determination of whether or not the system received a response to its transmission of the second signal. If a determination is made that the system did not receive a response to its transmission of the second signal, the process passes back to block 506. Referring again to block 540, if a determination is made that the system did receive a response to its transmission of the second signal, the process passes to block 542 which depicts the system storing the response it received to the second signal. This response is identified as the key received from the RFID tag.

Thereafter, block 544 illustrates the system attempting to decrypt the encrypted data that is stored on the disk using the key that was received from the RFID tag. Block 546, then, depicts a determination of whether or not the system was able to decrypt the data that is stored on the disk using the key the system received from the RFID tag that is affixed to the disk. If a determination is made that the system was able to decrypt the data using the key the system received from the RFID tag, the process passes to block 522 which illustrates the system playing the decrypted data. The process then terminates as depicted by block 524. Referring again to block 546, if a determination is made that the system was not able to decrypt the data using the key the system received from the RFID tag, the process terminates as depicted by block 524.

FIGS. 5B-1 and 5B-2 depict a high level flow chart that depicts copying data from a first system to a second system for playback by the second system at a later time without requiring the presence of the original digital storage medium in the second system during playback in accordance with the present invention. The process starts as depicted by block 550 and thereafter passes to block 552 which illustrates a determination of whether or not data that is stored on digital storage medium, such as a CD-ROM or DVD-ROM disk, is to be copied to another system for later playback without the original disk. If a determination is made that such data is not to be copied, the process passes back to block 552. If a determination is made that such data is to be copied, the process passes to block 554 which illustrates coupling a second computer system to a first computer system. The digital storage medium is inserted into a disk drive that is included within the first computer system.

The process then passes to block 556 which depicts the first computer system reading the public key from the second computer system. The public key is stored in the second computer system in storage that may be accessed by other computer systems. The public key is publicly available and need not be kept secret.

Next, block 558 illustrates the first system creating a certificate for this data that is to be copied. The process then passes to block 560 which depicts the first system storing an expiration date in the certificate. Thereafter, block 562 illustrates the first system transmitting a first signal at a first frequency. Block 564, then, depicts a determination of whether or not the first system has received a response to the transmission of its first signal. If a determination is made that no response was received to the first signal, the process terminates as illustrated by block 566.

Referring again to block 564, if a determination is made that the first system did receive a response to its first signal, the process passes to block 568 which depicts the first system storing the response it received. The response is stored in the first system and identified as the unique DMID that was received from the RFID tag that is affixed to the particular digital storage medium that was found inserted in the first system. Next, block 570 illustrates the first system reading the first field of the disk, i.e. the digital storage medium inserted in the first system, to obtain the DMID that is stored in the disk itself.

Thereafter, block 572 depicts the first system comparing the unique DMID that was received from the RFID tag to the unique DMID that was read from the disk itself. Block 574 illustrates a determination of whether or not the DMID received from the RFID tag is the same as the DMID that was found stored in the disk itself. If the two DMIDs are not the same, the process terminates as depicted by block 566. If the two DMIDs are the same, the process passes to block 576 which depicts the first system transmitting a second signal at a second frequency.

Next, block 578 illustrates a determination of whether or not the first system received a response to its transmission of the second signal. If a determination is made that the first system did not receive a response to its transmission of the second signal, the process terminates as depicted by block 566. Referring again to block 578, if a determination is made that the first system did receive a response to its transmission of the second signal, the process passes to block 580 which depicts the first system storing the response it received to the second signal. The response is identified as the key received from the RFID tag.

Thereafter, block 582 illustrates the first system attempting to decrypt the encrypted data that is stored on the disk using the key that was received from the RFID tag. Block 584, then, depicts a determination of whether or not the first system was able to decrypt the data that is stored on the disk using the key the system received from the RFID tag that is affixed to the disk. If a determination is made that the first system was not able to decrypt the data using the key the first system received from the RFID tag, the process terminates as illustrated by block 566.

Referring again to block 584, if a determination is made that the first system was able to decrypt the data using the key the first system received from the RFID tag, the process passes to block 586 which illustrates the first system using the certificate and the second system's public key that the first system read from the second system to re-encrypt the decrypted data. Next, block 588 depicts the first system storing the certificate and the re-encrypted data in the second system. The process then terminates as illustrated by block 566.

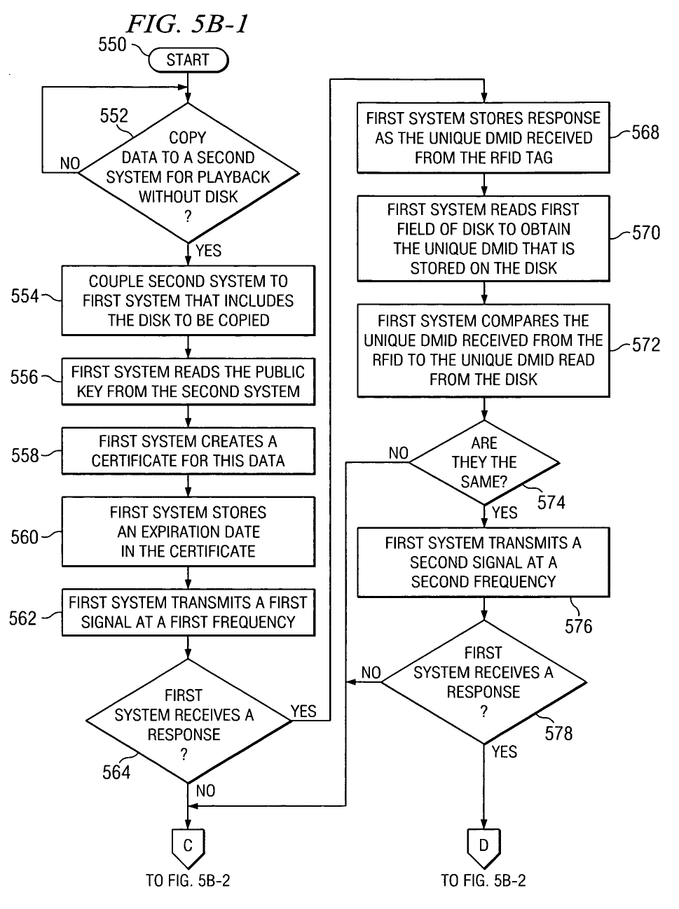

FIG. 6 illustrates a high level flow chart that depicts an RFID tag responding to a receipt of a first signal by transmitting data that is stored in a first field in the RFID tag in accordance with the present invention. The process starts as depicted by block 600 and thereafter passes to block 602 which illustrates the RFID tag receiving a first signal. Next, block 604 depicts the RFID tag responding to the first system by transmitting the data that is stored in the RFID tag's first field. The data that is stored in the RFID tag's first field should be the particular DMID that is associated with the disk to which this RFID is affixed. The process then terminates as illustrated by block 606.

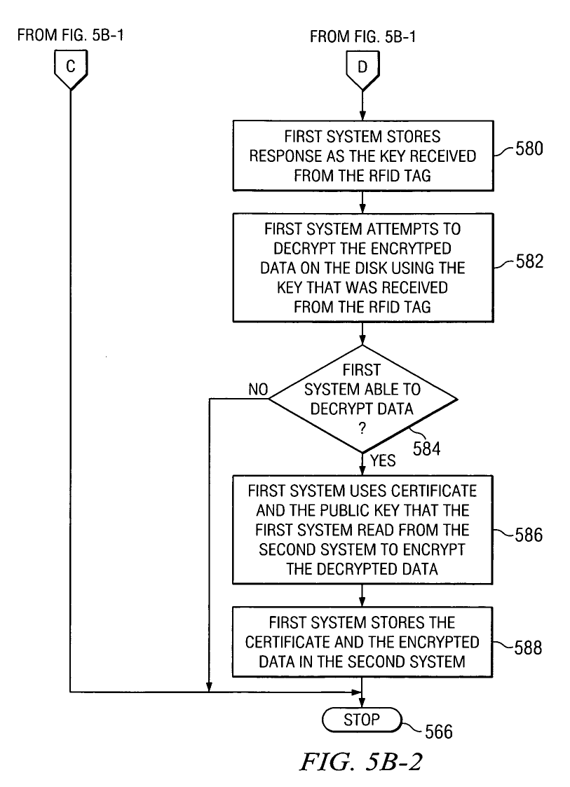

FIG. 7 depicts a high level flow chart that illustrates an RFID tag responding to a receipt of a second signal by transmitting data that is stored in a second field in the RFID tag in accordance with the present invention. The process starts as depicted by block 700 and thereafter passes to block 702 which illustrates the RFID tag receiving a second signal. Next, block 704 depicts the RFID tag responding to the second system by transmitting the data that is stored in the RFID tag's second field. The data that is stored in the RFID tag's second field should be the particular public key that has been assigned to the disk to which this RFID is affixed. The process then terminates as illustrated by block 706.

It is important to note that while the present invention has been described in the context of a fully functioning data processing system. Those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data storage device for controlling copying and playback of digital data, said method comprising:
selecting digital data to be stored using a portable digital storage medium, data that is stored using said medium capable of being accessed only when said medium is inserted into a drive that can be accessed by a data processing system; and
during manufacturing of said medium:
storing a unique identifier within said medium, said unique identifier identifying said medium;
storing a copy of said unique identifier in a first field in a tag that is affixed to a surface of said medium;
selecting a public key/private key pair for encryption and decryption of data, data that has been encrypted using said private key capable of being decrypted using only said public key;
storing said public key in a second field within said tag;
encrypting said digital data using said private key; and
storing said encrypted data using said medium.

2. The method according to claim 1, further comprising:
said digital storage medium being a CD-ROM.

3. The method according to claim 1, further comprising:
requiring said tag to be present in order to decrypt said encrypted data, said encrypted data being unable to be accessed without said tag being present.

4. The method according to claim 1, further comprising:
attempting to access said encrypted digital data that is stored utilizing said medium;
reading said unique identifier from said medium;
attempting to read data that is stored in said first field in said tag;
in response to reading data from said tag that is stored in said first field, determining whether said unique identifier that was read from said medium matches said data that was read from said first field in said tag;
in response to said unique identifier that was read from said medium being different from said data that was read from said first field in said tag, prohibiting access to said encrypted digital data.

5. The method according to claim 4, further comprising:
in response to said unique identifier that was read from said medium being the same as said data that that was read from said first field in said tag, reading data that is stored in said second field in said tag;
attempting to decrypt said encrypted data using said data that was read from said second field in said tag;
in response to successfully decrypting said encrypted data, accessing said successfully decrypted data; and
in response to unsuccessfully decrypting said encrypted data, prohibiting access to said encrypted data.

6. The method according to claim 5, further comprising:
attempting to copy said decrypted digital data to a second device;
retrieving a public key from said second device, said device storing a public key and private key pair, said public key being available to be read, said private key being kept private within said second device wherein said private key cannot be accessed read from a device that is outside of said second device;
generating a certificate;
storing an expiration date in said certificate said certificate being valid until said expiration date;
re-encrypting said decrypted data using said certificate and said public key that was retrieved from said second system; and
storing said re-encrypted data and said certificate in said second device.

7. The method according to claim 6, further comprising:
attempting, by said second device, to access said re-encrypted data;
searching for a certificate that is associated with said re-encrypted data;
in response to finding said certificate that is associated with said re-encrypted data, reading an expiration date that is stored in said certificate, said certificate being valid until said expiration date;
in response to said certificate being valid, attempting, by said second system, to decrypt said re-encrypted data using said certificate and a private key that is stored in said second system;
in response to successfully decrypting said re-encrypted data using said certificate and said private key, accessing said successfully decrypted data; and
in response to unsuccessfully decrypting said re-encrypted data using said certificate and said private key, prohibiting access to said re-encrypted data.

8. The method according to claim 7, further comprising:
in response to said certificate being invalid, prohibiting access to said encrypted data.

9. An apparatus for controlling copying and playback of digital data, said apparatus comprising:
digital data to be stored using a portable digital storage medium, data that is stored using said medium capable of being accessed only when said medium is inserted into a drive that can be accessed by a data processing system; and
during manufacturing of said medium:
a unique identifier being stored within said medium, said unique identifier identifying said medium;
a copy of said unique identifier being stored in a first field in a tag that is affixed to a surface of said medium;
a public key/private key pair for encryption and decryption of data selected for said medium, data that has been encrypted using said private key capable of being decrypted using only said public key;
said public key being stored in a second field within said tag;
said digital data encrypted using said private key; and
said medium for storing said encrypted data.

10. The apparatus according to claim 9, further comprising:
said digital storage medium being a CD-ROM.

11. The apparatus according to claim 9, further comprising:
said tag required to be present in order to decrypt said encrypted data, said encrypted data being unable to be accessed without said tag being present.

12. The apparatus according to claim 9, further comprising:
said medium being inserted into a drive in a data processing system;
said system for attempting to access said encrypted digital data that is stored utilizing said medium;
said system for reading said unique identifier from said medium;
said system for attempting to read data that is stored in said first field in said tag;
in response to reading data from said tag that is stored in said first field, said system for determining whether said unique identifier that was read from said medium matches said data that was read from said first field in said tag;
in response to said unique identifier that was read from said medium being different from said data that was read from said first field in said tag, access to said encrypted digital data being prohibited.

13. The apparatus according to claim 12, further comprising:
in response to said unique identifier that was read from said medium being the same as said data that that was read from said first field in said tag, said system for reading data that is stored in said second field in said tag;
said system for attempting to decrypt said encrypted data using said data that was read from said second field in said tag;
in response to successfully decrypting said encrypted data, said system for accessing said successfully decrypted data; and
in response to unsuccessfully decrypting said encrypted data, access to said encrypted data being prohibited.

14. The apparatus according to claim 13, further comprising:
said system for attempting to copy said decrypted digital data to a second device;
said system for retrieving a public key from said second device, said device storing a public key and private key pair, said public key being available to be read, said private key being kept private within said second device wherein said private key cannot be accessed read from a device that is outside of said second device;
said system for generating a certificate;
said system for storing an expiration date in said certificate said certificate being valid until said expiration date;
said system for re-encrypting said decrypted data using said certificate and said public key that was retrieved from said second system; and
said second device for storing said re-encrypted data and said certificate.

15. The apparatus according to claim 14, further comprising:
said second device attempting to access said re-encrypted data;
said second device searching for a certificate that is associated with said re-encrypted data;
in response to finding said certificate that is associated with said re-encrypted data, said second device reading an expiration date that is stored in said certificate, said certificate being valid until said expiration date;
in response to said certificate being valid, said second system attempting to decrypt said re-encrypted data using said certificate and a private key that is stored in said second system;
in response to successfully decrypting said re-encrypted data using said certificate and said private key, said second device accessing said successfully decrypted data; and
in response to unsuccessfully decrypting said re-encrypted data using said certificate and said private key, access to said re-encrypted data being prohibited.

16. The apparatus according to claim 15, further comprising:
in response to said certificate being invalid, access to said encrypted data being prohibited.

17. A computer program product for controlling copying and playback of digital data, said product comprising:
instructions for selecting digital data to be stored using a portable digital storage medium, data that is stored using said medium capable of being accessed only when said medium is inserted into a drive that can be accessed by a data processing system; and
during manufacturing of said medium:
instructions for storing a unique identifier within said medium, said unique identifier identifying said medium;
storing a copy of said unique identifier in a first field in a tag that is affixed to a surface of said medium;
instructions for selecting a public key/private key pair for encryption and decryption of data, data that has been encrypted using said private key capable of being decrypted using only said public key;
instructions for storing said public key in a second field within said tag;
instructions for encrypting said digital data using said private key; and
instructions for storing said encrypted data using said medium.

18. The product according to claim 17, further comprising:
instructions for attempting to access said encrypted digital data that is stored utilizing said medium;
instructions for reading said unique identifier from said medium;
instructions for attempting to read data that is stored in said first field in said tag;
in response to reading data from said tag that is stored in said first field, instructions for determining whether said unique identifier that was read from said medium matches said data that was read from said first field in said tag;
in response to said unique identifier that was read from said medium being different from said data that was read from said first field in said tag, instructions for prohibiting access to said encrypted digital data;
in response to said unique identifier that was read from said medium being the same as said data that that was read from said first field in said tag, instructions for reading data that is stored in said second field in said tag;
instructions for attempting to decrypt said encrypted data using said data that was read from said second field in said tag;
in response to successfully decrypting said encrypted data, instructions for accessing said successfully decrypted data; and
in response to unsuccessfully decrypting said encrypted data, instructions for prohibiting access to said encrypted data.

19. The product according to claim 18, further comprising:
instructions for attempting to copy said decrypted digital data to a second device;
instructions for retrieving a public key from said second device, said device storing a public key and private key pair, said public key being available to be read, said private key being kept private within said second device wherein said private key cannot be accessed read from a device that is outside of said second device;
instructions for generating a certificate;
instructions for storing an expiration date in said certificate said certificate being valid until said expiration date;
instructions for re-encrypting said decrypted data using said certificate and said public key that was retrieved from said second system; and
instructions for storing said re-encrypted data and said certificate in said second device.

20. The product according to claim 19, further comprising:
instructions for attempting, by said second device, to access said re-encrypted data;
instructions for searching for a certificate that is associated with said re-encrypted data;
in response to finding said certificate that is associated with said re-encrypted data, instructions for reading an expiration date that is stored in said certificate, said certificate being valid until said expiration date;
in response to said certificate being valid, instructions for attempting, by said second system, to decrypt said re-encrypted data using said certificate and a private key that is stored in said second system;
in response to successfully decrypting said re-encrypted data using said certificate and said private key, instructions for accessing said successfully decrypted data; and
in response to unsuccessfully decrypting said re-encrypted data using said certificate and said private key, instructions for prohibiting access to said re-encrypted data.
